(19) United States
(12) Patent Application Publication
(10) Pub. No.: US 2007/0015915 A1
(43) Pub. Date: Jan. 18, 2007

(54) Method of preparing percarboxy-cyclodextrins by means of regioselective oxidation at position 6 of alpha-, beta-, or gamma- cyclodextrins and applications thereof

(75) Inventors: Mustapha El Belgsir, Poitiers (FR); Denis Liaigre, St. Aubin-Le-Cloud (FR); Tony Breton, Perigny (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Breese Derambure Majerowicz, Paris (FR)

(21) Appl. No.: 11/412,899

(22) Filed: Apr. 28, 2006

(30) Foreign Application Priority Data
Oct. 29, 2004 (WO) PCT/FR04/50552
Oct. 29, 2003 (FR) 0312684

(51) Int. Cl. C08B 37/16; C25B 3/00

(52) U.S. Cl. 536/103; 205/421

(57) ABSTRACT

Method for the regioselective oxidation of a cyclodextrin, comprising contacting an α-, β-, or γ-cyclodextrin with an oxidation mediator in a stoichiometric quantity.

The present invention relates to a novel method for the regioselective oxidation of all the primary hydroxyl functions at position 6 of the glucopyranoside units of α-, β-, γ-cyclodextrins, with a view to preparing per-6-deoxy-6-carboxy-cyclomalto-hexaose, heptaose or octaose. The method according to the invention has the advantage of precisely controlling the degree of substitution of the primary hydroxyls at position 6 of the cyclodextrins.

Cyclodextrins are used in particular as an inclusion agent and are widely used in the agri-food industry, in the cosmetics industry and in the chemical, agrochemical and pharmaceutical industry. In solution, cyclodextrins form chlathrates or complexes with hydrophobic compounds which are insoluble or sparingly soluble in water, and make it possible to increase the solubility of these compounds. Cyclodextrins are also used to trap pollutants when they are immobilized on supports, and these supports can also be used as a chromatographic stationary phase.

Due to their oxidoreductive properties, aminoxyl radicals are reactants which are highly suitable for the regioselective oxidation of primary alcohols. 2,2,6,6-Tetramethyl-1-piperidinyloxy, known as the TEMPO radical, was one of the first to be synthesized. WO 03/06435 describes the use of such a radical in combination with iodine for the selective oxidation of primary alcohols. FR2804437 describes the incomplete oxidation of cyclodextrins in a regioselective manner at position 6 in the presence of TEMPO and sodium hypochlorite and sodium bromide, and obtains mono-6-deoxy-6-carboxy, di-(6-deoxy-6-carboxy) or tri-(6-deoxy-6-carboxy), cyclomalto-hexaose, heptaose or octaose. The use of halides has the significant disadvantage of releasing halogens which are particularly harmful to the environment. Moreover, this method does not make it possible to oxidize all the primary hydroxyl functions at position 6 of a cyclodextrin, but rather just one, two or three of said functions.

The invention aims to overcome these disadvantages and proposes a method which is kind to the environment and makes it possible to oxidize in a regioselective manner all the primary hydroxyl functions at position 6 of α-, β-, γ-cyclodextrins, while controlling the degree of substitution of these primary hydroxyl functions, and thus the amount of uronic acid on a cyclodextrin.

The invention relates more particularly to a method for the regioselective oxidation of a cyclodextrin, characterized in that this cyclodextrin is subjected to the oxidizing action of an oxidation mediator which is preferably the oxoammonium ion, optionally in the presence of a parallel redox system which enables the in situ regeneration of the used oxidation mediator. Oxoammonium ions are obtained by oxidation of aminoxyl radicals and have dehydrogenating properties which are used to bring about the oxidation of the primary alcohols.

The oxidoreductive properties of aminoxyl groups are shown below.

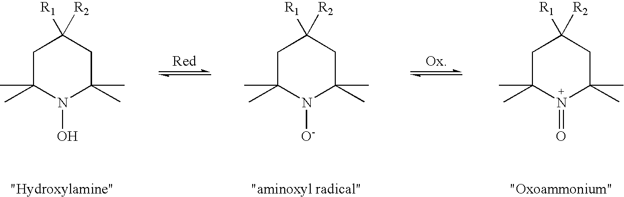

### Oxidoreductive Properties of Aminoxyl Groups

According to a first embodiment of the invention, the oxidation mediator may be used in a stoichiometric quantity, and in this case it is synthesized prior to the oxidation reaction, as shown in Example 1 below.

According to a second embodiment of the invention, the oxidation mediator, which is preferably the oxoammonium ion, is used in a catalytic quantity accompanied by a parallel redox system which enables the in situ regeneration of the used mediator and, in the embodiment in which the oxidation mediator is the oxoammonium ion, of the used oxoammoniums from the reduced form (hydroxylamine) obtained after dehydrogenation of the alcohol function.

According to one preferred embodiment of the invention, the aminoxyl radical used is the TEMPO radical, 2,2,6,6-tetramethylpiperidine-1-oxyl, or one of its derivatives.

This regeneration may be carried out by using a redox assistant, but also by means of an electrochemical system.

The reaction mechanism of the oxidation of primary hydroxyl functions by means of TEMPO assisted by an electrochemical system is shown below:

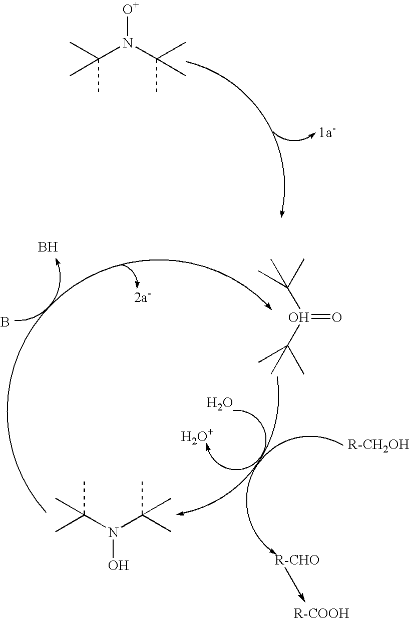

The aminoxyl radical is firstly oxidized at the anode with exchange of an electron. The oxoammonium thus formed dehydrogenates a primary alcohol function to form an aldehyde, in the process reducing to hydroxylamine. The aldehyde will then hydrate instantaneously while the oxoammonium is regenerated at the anode from the hydroxylamine by exchanging two electrons and in the presence of a base capable of accepting a proton. The catalytic cycle is carried out again on the hydrated aldehyde function to form the corresponding carboxylic acid.

According to one preferred embodiment of the invention, the method carries out an oxidation by means of an oxidation mediator which is preferably an oxoammonium ion, regenerated by an electrochemical system. The invention also relates to a device for implementing a catalytic oxidation method associated with a system for the in situ regeneration of the oxidation mediator. Advantageously, the electrolysis operations are carried out in a thermostatically controlled Pyrex cell with one or two compartments, comprising a system with two or three electrodes:
a working electrode (WE),
a counter-electrode (CE) which is separated by any method from the working electrode by an ion exchange membrane which allows the passage of current but prevents the reduction of the oxoammoniums produced at the anode,
a reference electrode (in the case of the system with three electrodes).

According to one preferred embodiment of the invention, the electrochemical system which assists the oxidation is a system with three electrodes. Preferably, the oxidation mediator is regenerated at the anode of the electrochemical system, that is to say at the working electrode, preferably in the presence of a base capable of accepting a proton.

According to a first embodiment of the invention, the oxidation mediator is in solution. According to a second embodiment of the invention, the oxidation mediator is immobilized on an electrode.

Preferably, the electronic assembly consists of a voltage generator, a potentiostat (in the case of the system with three electrodes) and of a coulometer which makes it possible to monitor the number of coulombs exchanged.

Advantageously, the reaction temperature is between 0 and 40° C., preferably between 0 and 5° C.

According to one preferred embodiment of the invention, the quantity of electricity exchanged during the oxidation reaction is controlled and is preferably equal to or advantageously slightly greater than 4 Faraday per equivalent of primary alcohol function (24 Faraday for alpha-, 28 Faraday for beta- and 32 Faraday for gamma-cyclodextrin).

The invention will be better understood on reading the following examples, which illustrate the invention in a non-limiting manner.

### EXAMPLE 1

### Oxidation of β-cyclodextrin by a Stoichiometric Quantity of Oxoammonium Salts

1) Preparation of Oxoammonium.

This is a disproportionation reaction in the presence of a strong mineral acid: 12.79 g (60 mmol) of radical are dissolved in a minimum amount of dichloromethane. The solution is vigorously stirred for half an hour following the dropwise addition of 3.1 ml (1.5 equivalents) of 70% perchloric acid. After filtration of the yellow precipitate through a sintered glass filter, washing with DCM and drying, 8.95 g (28.6 mmol) of product are obtained (yield 95%).

2) Oxidation Reaction.

5.91 g (19 mmol) of oxoammonium salt and 1 g (881 μmol) of β-cyclodextrin are dissolved separately in a minimum amount of water. The reaction mixture is gently stirred overnight following the dropwise addition of the β-CD solution to that of the mediator. After extraction with dichloromethane, neutralization of the aqueous phase with a sodium carbonate solution, evaporation of the water and washing with acetonitrile, 0.968 g (785 μmol) of fully oxidized β-cyclodextrin is obtained.

### EXAMPLE 2

### Oxidation of β-cyclodextrin in Homogeneous Phase by a Catalytic Quantity of TEMPO, Regeneration Being Carried Out by Means of the Electrochemical System

0.200 g (176 μmol) of β-cyclodextrin and 0.15 equivalent of TEMPO (0.029 g, 185 μmol) are dissolved in 50 ml of a carbonate buffer solution (1M NaHCO₃, 1M Na₂CO₃). Electrolysis is carried out with stirring at 2° C. and at a fixed potential of 0.50 V/ESM. After 24 hours of electrolysis, 476 C are used. The crude is then extracted with 3×10 ml of dichlormethane. The reaction medium is then neutralized with a 0.05M hydrochloric acid solution.

The solution is partially concentrated under reduced pressure at a temperature of 40° C. then is placed on a Biogel P6 column eluted with a 0.05M sodium nitrate solution, so as to separate the various constituents.

After desalination, the purity is checked by means of thin layer chromatography on a silica plate. The eluent is an acetonitrile/water mixture (7:3). The plates are developed by dipping them in a 5% phosphomolybdic acid/ethanol mixture and then heating them to 300° C.

Finally, the product is lyophilized then analysed by ¹³C/¹H NMR, HPLC and MS.

The reaction yield is 89% with a selectivity of 100% and a faradaic yield of close to 100%.

### EXAMPLES 3 AND 4

These examples relate respectively to the oxidation of α-cyclodextrin and of γ-cyclodextrin in homogeneous phase by a catalytic quantity of TEMPO, regeneration being carried out by means of the electrochemical system.

The conditions for electrolysis and purification steps, carried out on 325 mg of α-cyclodextrin and on 500 mg of γ-cyclodextrin, are the same as in Example 1. The results obtained are shown in the following table:

TABLE 1
Oxidation of α- and γ-cyclodextrin

| | Conversion | | Chemical | Faradaic |
|---|---|---|---|---|
| | rate | Selectivity | yield | yield |
| α-CD | 100% | 86% | 86% | 100% |
| γ-CD | 100% | 95% | 95% | 100% |

### EXAMPLE 5

In this embodiment, the aminoxyl radical is used in a catalytic quantity. The regeneration of the active form is carried out by the electrochemical system. In this particular embodiment, the oxidation mediator is immobilized on the working electrode, which involves working in the heterogeneous phase. This embodiment makes it possible to improve the reaction rates.

The electrochemically assisted catalytic cycle is shown below. It comprises the phases of oxidation, activation and regeneration. 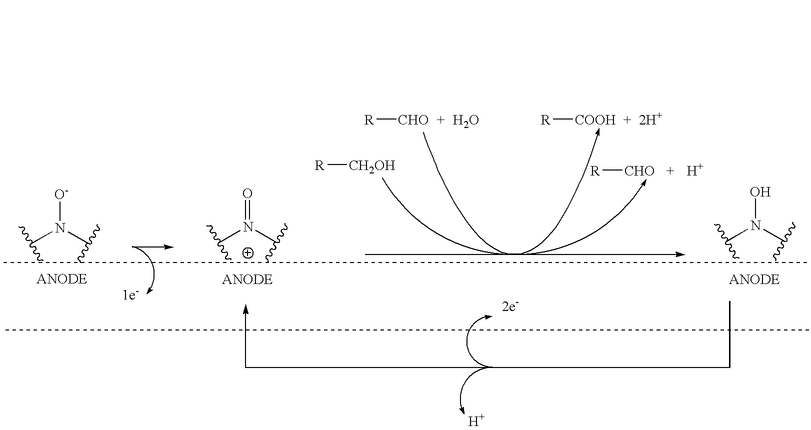
1st Step: Preparation of the Electrode

The carbon felt electrode (1*2*0.2 cm³) is firstly extracted with methanol in a soxhlet extractor for 4 hours. After drying, the electrode is soaked with 0.5 ml of a Nafion solution containing 50 mg (0.32 mmol) of TEMPO. The electrode is then carefully dried at room temperature for 48 hours.

2nd Step: Oxidation Reaction

200 mg of β-cyclodextrin (176 μmol) are dissolved in 50 cm³ of support electrolyte (1M NaHCO₃, 1M Na₂CO₃). The electrolysis potential is set at 0.300 V/ESM. After 24 hours of electrolysis, 476 C are exchanged.

The purification carried out is the same as in Example 1.

The chemical yield of the reaction is 94% and the faradaic yield is 92%.

In a surprising manner, the inventors found that controlling certain experimental parameters, and in particular the quantity of electricity exchanged during the oxidation reaction and the temperature, made it possible to obtain better selectivity with regard to the formation of “peroxidized” cyclodextrin derivatives.

1. Method for the regioselective oxidation of a cyclodextrin, comprising contacting an α-, α-, or γ-cyclodextrin with an oxidation mediator in a stoichiometric quantity.

2. Method for the regioselective oxidation of a cyclodextrin, comprising contacting an α-, β-, or γ-cyclodextrin with an oxidation mediator in a catalytic quantity in the presence of a parallel redox system that enables the in situ regeneration of the used oxidation mediator, wherein said redox system is a redox assistant or an electrochemical system with electrodes separated by an ion exchange membrane.

3. The method of claim 1 or 2, wherein the oxidation mediator is an oxoammonium ion.

4. The method of claim 1 or 2, wherein said oxoammonium ion is obtained by oxidation of an aminoxyl radical.

5. The method of claim 4, wherein said radical is a 2,2,6,6-tetramethylpiperidine-1-oxyl radical or a derivative thereof.

6. The method of claim 1, wherein the method comprises a step of synthesizing the oxidation mediator prior to the oxidation.

7. (canceled)

8. The method of claim 2, wherein said electrochemical system comprises two or three electrodes.

9. The method of claim 2, wherein said oxidation mediator is regenerated at an anode of the electrochemical system.

10. The method of claim 1 or 2, wherein the oxidation mediator is in solution.

11. The method of claim 2, wherein the oxidation mediator is immobilized on an electrode.

12. The method of claim 1 or 2, wherein the reaction temperature is between 0 and 40° C.

13. The method of claim 2, wherein the quantity of electricity exchanged during the oxidation reaction is controlled.

14. The method of claim 1 or 2, wherein all primary hydroxyl functions at position 6 of α-, β-, γ-cyclodextrin are oxidized.

15. The method of claim 14, wherein per-6-deoxy-6-carboxy-cyclomalto-hexaose, heptaose or octaose is prepared.

16. Device for implementing an oxidation by means of an oxoammonium ion regenerated by an electrochemical system, wherein said electrochemical system comprising two or three electrodes.

17. The device of claim 16, wherein said system comprises a working electrode, a counter-electrode which is separated from the working electrode by an ion exchange membrane, and optionally a reference electrode.

18. The device of claim 16 or 17, further comprising a thermostatically controlled cell, a voltage generator, a coulometer and optionally a potentiostat.

19. The method of claim 8, wherein said system comprises three electrodes.

20. The method of claim 9, wherein said oxidation mediator is regenerated in the presence of a base capable of accepting a proton.

21. The method of claim 12, wherein the reaction temperature is 0 and 5° C.

22. the method of claim 13, wherein the quantity of electricity exchanged is greater than 4 Faraday per equivalent of alcohol function to be oxidized.

23. The device of claim 16, wherein said system comprises three electrodes.
